(19) United States
(12) Patent Application Publication
(10) Pub. No.: US 2013/0277327 A1
(43) Pub. Date: Oct. 24, 2013

(54) HEAT-INSULATION SAFETY NURSING BOTTLE

(71) Applicant: CHIN-LONG FONG, NEW TAIPEI CITY (TW)

(72) Inventor: CHIN-LONG FONG, NEW TAIPEI CITY (TW)

(21) Appl. No.: 13/453,111

(22) Filed: Apr. 23, 2012

(51) Int. Cl. A61J 9/08; A61J 9/04; A61J 11/00

(52) U.S. Cl. 215/11.5; 215/11.6

(57) ABSTRACT

A heat-insulation safety nursing bottle includes a nursing bottle body, a heat shield cap fastened to the bottleneck of the nursing bottle body to hold down a nipple, and a cylindrical heat shield body fastened to the heat shield cap and surrounding the nursing bottle body for holding by a baby or nursing mother to prevent scalding. The cylindrical heat shield body prohibits the baby from touching or eating broken chips if the nursing bottle body is broken accidentally.

### BACKGROUND OF THE INVENTION

1. Field of the Invention

The present invention relates to nursing bottles and more particularly, to a heat-insulation safety nursing bottle, which prevents scalding the hands of the baby or nursing mother, and prohibits the baby from touching or eating broken chips if the nursing bottle body is broken accidentally.

2. Description of the Related Art

Conventional nursing bottles are commonly made of glass or plastics. A glass nursing bottle is heat resistant and non-toxic, and has a long lifespan. A plastic nursing bottle is not heat resistant and can be toxic when holding a hot fluid. Further, a plastic nursing bottle has a short lifespan. Therefore, most parents use a glass nursing bottle to nurse their baby with milk or water during the stage where the baby cannot grasp an object or walk. However, a glass bottle is fragile. When a glass bottle falls to the ground, it may break into pieces, causing accidental injuries. Further, a baby may pick up and eat broken glass chips. Thus, when a baby is growing up and able to grasp objects or to walk, a plastic bottle may be used to substitute for a glass nursing bottle during this stage, despite of its various drawbacks in usage.

### SUMMARY OF THE INVENTION

The present invention has been accomplished under the circumstances in view. It is the main object of the present invention to provide a heat-insulation safety nursing bottle, which prevents scalding the hands of the baby or nursing mother, and prohibits the baby from touching or eating broken chips if the nursing bottle body is broken accidentally.

To achieve this and other objects of the present invention, a nursing bottle comprises a nursing bottle body having an outer thread extending around the periphery of the bottleneck thereof, a nipple mounted on the bottleneck of the nursing bottle body, a heat shield cap fastened to the bottleneck of the nursing bottle body by a screw joint to hold down the nipple, and a cylindrical heat shield body fastened to the heat shield cap by a screw joint and surrounding the nursing bottle body at a predetermined distance for holding by a baby or nursing mother to prevent direct transfer of heat from the milk or fluid in the nursing bottle body to the hands of the baby or nursing mother. If the nursing bottle body is broken accidentally, the cylindrical heat shield body keeps the broken chips on the inside, preventing the baby from touching or eating the broken chips.

In an alternate form of the present invention, the nursing bottle body has a bottom opening sealed by a breathing bottom cover. The breathing bottom cover has a crevice formed in a center rounded cone thereof. The crevice is normally closed subject to the elastic material property of the breathing bottom cover. When the nursing bottle body is tilted and the baby is sucking in the milk or drinking fluid from the nursing bottle body, the internal and external pressures of the nursing bottle body are not balanced, at this time, outside air pushes open the crevice and enters the inside of the nursing bottle body, allowing the mild or drinking fluid to be sucked out of the nipple into the baby's mouth.

Further, the breathing bottom cover can be removed from the bottom opening of the nursing bottle body, facilitating cleaning of the nursing bottle body.

### BRIEF DESCRIPTION OF THE DRAWING

FIG. 1 is an exploded view of a heat-insulation safety nursing bottle in accordance with a first embodiment of the present invention.

FIG. 2 is a sectional side view of the heat-insulation safety nursing bottle in accordance with the first embodiment of the present invention.

FIG. 3 is a schematic sectional view illustrating the nursing bottle body broken and broken chips of the nursing bottle body kept inside the heat shield in accordance with the first embodiment of the present invention.

FIG. 4 is an exploded view of a heat-insulation safety nursing bottle in accordance with a second embodiment of the present invention.

FIG. 5 is a sectional side view of the nursing bottle in accordance with the second embodiment of the present invention.

### DETAILED DESCRIPTION OF THE PREFERRED EMBODIMENT

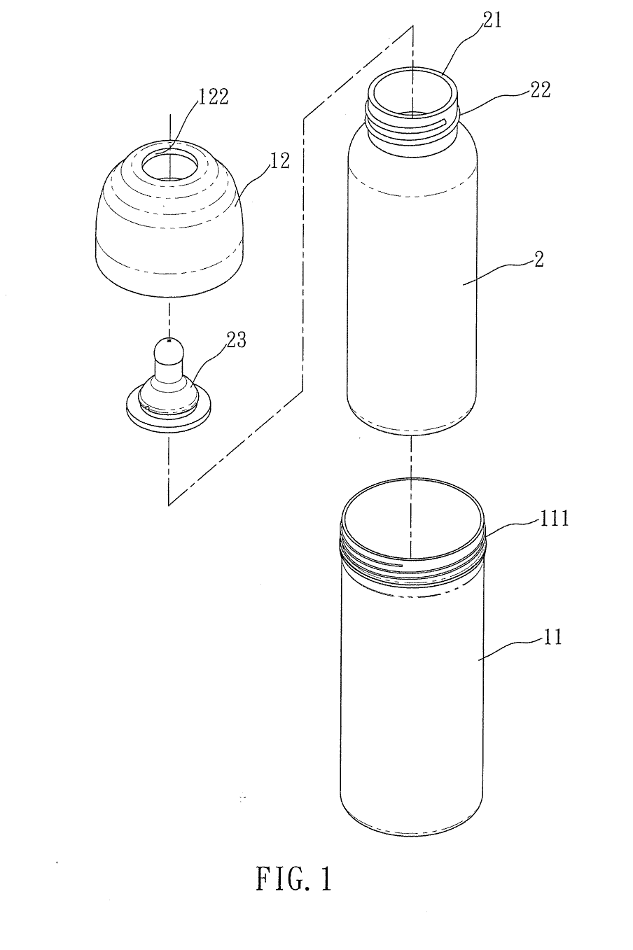

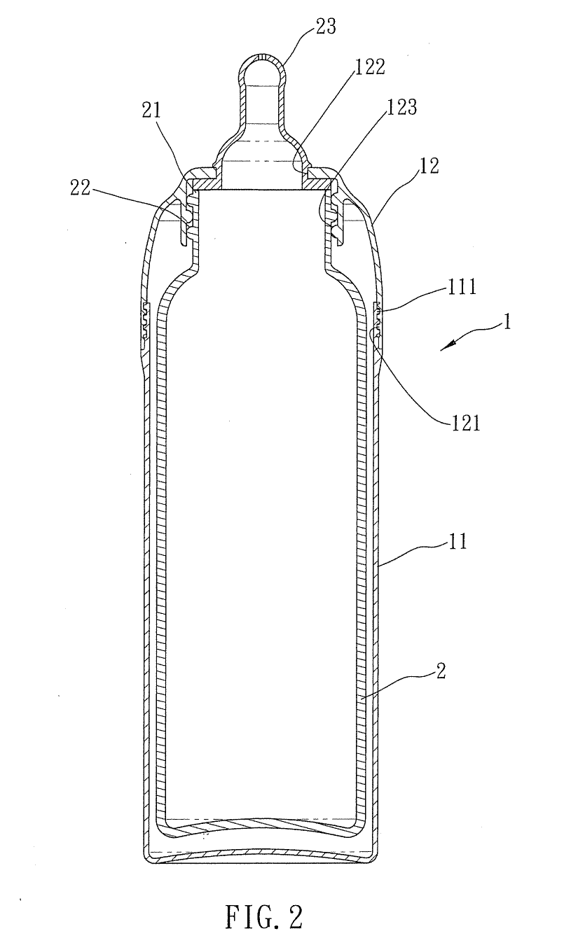

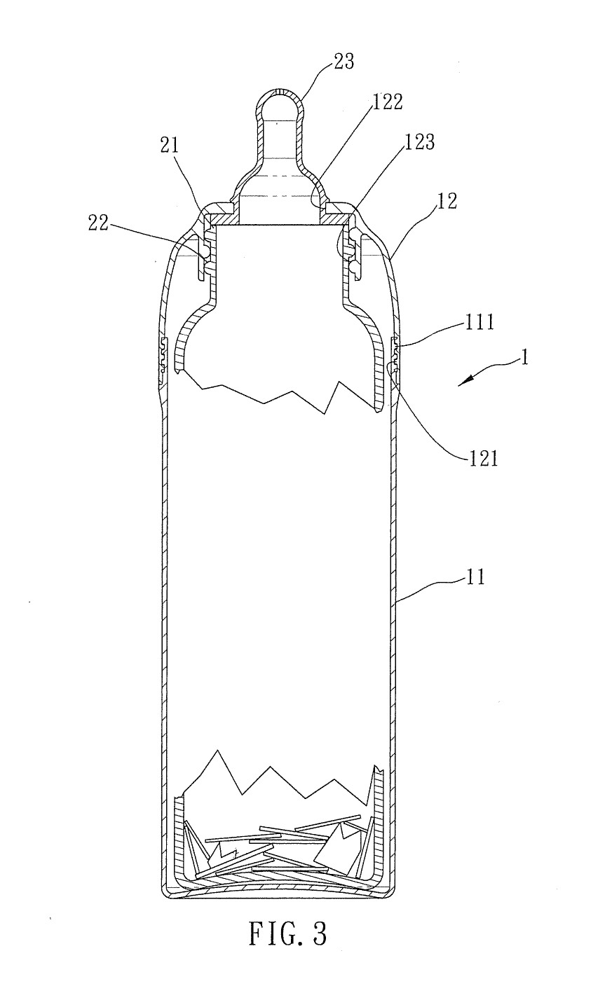

Referring to FIGS. 1, 2 and 3, a heat-insulation safety nursing bottle in accordance with a first embodiment of the present invention is shown. The nursing bottle comprises a nursing bottle body 2, a nipple 23 configured subject to International Standards Organization (ISO) standards and fastened to the nursing bottle body 2, and a heat shield 1 surrounding the nursing bottle body 2. The heat shield 1 comprises a cylindrical heat shield body 11, which comprises an outer thread 111 extending around the periphery near the topmost edge thereof, and a heat shield cap 12, which comprises a first inner thread 121 disposed near a bottom side thereof and threaded onto the outer thread 111 of the cylindrical heat shield body 11, a center mounting through hole 122, and a second inner thread 123 spaced above the first inner thread 121 and disposed adjacent to the center mounting through hole 122. The nursing bottle body 2 comprises a bottleneck 21, and an outer thread 22 extending around the periphery of the bottleneck 21. The second inner thread 123 of the heat shield cap 12 is threaded onto the outer thread 22 of the nursing bottle body 2 to lock the nipple 23 to the bottleneck 21 of the nursing bottle body 2. When the nursing bottle is assembled, the heat shield cap 12 of the heat shield 1 is secured to the bottleneck 21 of the nursing bottle body 2, and the cylindrical heat shield body 11 of the heat shield 1 is spaced around the nursing bottle body 2, avoiding direct transfer of heat from the milk in the nursing bottle body 2 to the cylindrical heat shield body 11 of the heat shield 1, and therefore the cylindrical heat shield body 11 does not scald the user's hand. Further, the cylindrical heat shield body 11 of the heat shield 1 protects the nursing bottle body 2 against breaking. Even if the nursing bottle body 2 is broken, the broken chips can be kept inside the cylindrical heat shield body 11 of the heat shield 1, prohibiting the baby from touching or eating the broken chips.

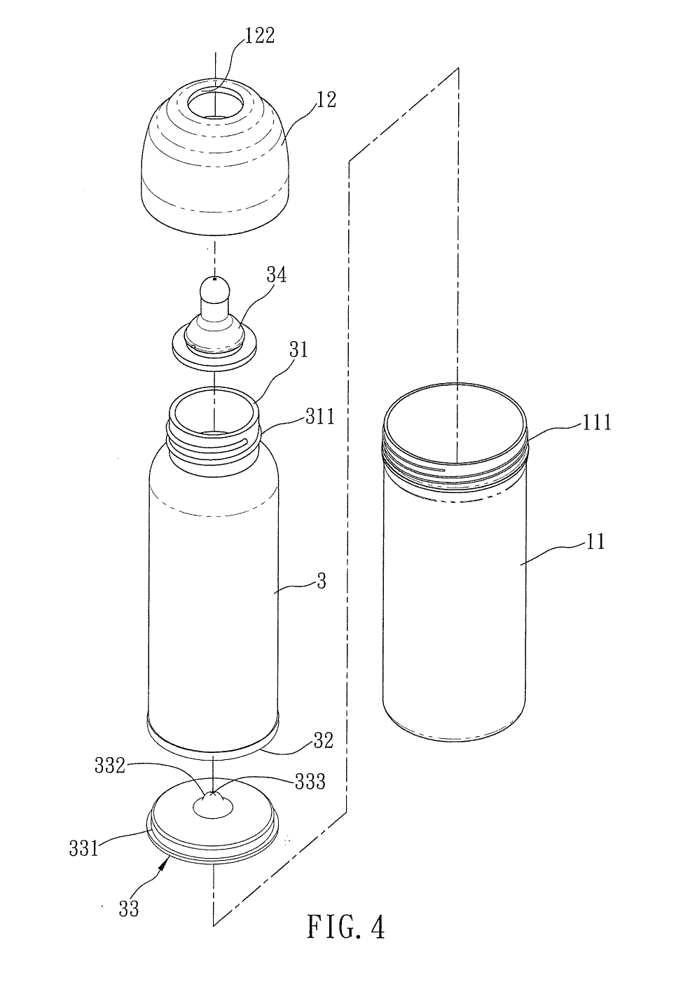

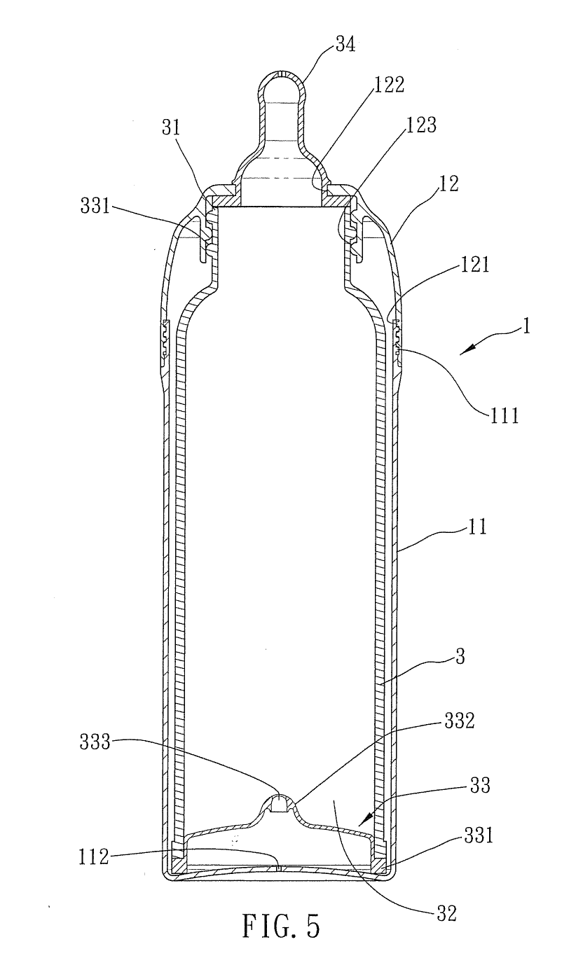

Referring to FIGS. 4 and 5, a heat-insulation safety nursing bottle in accordance with a second embodiment of the present invention is shown. The heat-insulation safety nursing bottle comprises a nursing bottle body 3, a nipple 34 configured subject to International Standards Organization (ISO) standards and fastened to the nursing bottle body 3, and a heat shield 1 surrounding the nursing bottle body 3. The heat shield 1 comprises a cylindrical heat shield body 11, which comprises an outer thread 111 extending around the periphery near the topmost edge thereof and an air vent 112 at the bottom side thereof, and a heat shield cap 12, which comprises a first inner thread 121 disposed near a bottom side thereof and threaded onto the outer thread 111 of the cylindrical heat shield body 11, a center mounting through hole 122, and a second inner thread 123 spaced above the first inner thread 121 and disposed adjacent to the center mounting through hole 122. The nursing bottle body 3 comprises a bottleneck 31, an outer thread 311 extending around the periphery of the bottleneck 31, a bottom opening 32, and a breathing bottom cover 33 fastened to the bottom opening 32. The second inner thread 123 of the heat shield cap 12 is threaded onto the outer thread 311 of the nursing bottle body 3 to lock the nipple 34 to the bottleneck 31 of the nursing bottle body 3. The breathing bottom cover 33 is made of silicon rubber and press-fitted into the bottom opening 32 of the nursing bottle body 3, comprising a rim 331 extending around of the periphery thereof at a bottom side and stopped against the bottom edge of the nursing bottle body 3 outside the bottom opening 32, a center rounded cone 332 disposed at the center thereof, and a straight or crossed crevice 333 formed in the rounded cone 332. When the nursing bottle body 3 holds milk or a drinking fluid therein and the internal and external pressures of the nursing bottle body 3 are balanced, the gravity weight of the milk or drinking fluid in the nursing bottle body 3 forces the center rounded cone 332 to close the straight or crossed crevice 333. When the nursing bottle body 3 is tilted and the baby is sucking in the milk or drinking fluid from the nursing bottle body 3, the internal and external pressures of the nursing bottle body 3 are not balanced, at this time, outside air pushes open the straight or crossed crevice 333 and enters the inside of the nursing bottle body 3, allowing the mild or drinking fluid to be sucked out of the nipple 34 into the baby's mouth.

Because the heat shield cap 12 of the heat shield 1 is secured to the bottleneck 31 of the nursing bottle body 3, and the cylindrical heat shield body 11 of the heat shield 1 is spaced around the nursing bottle body 3, heat will not be directly transferred from the milk in the nursing bottle body 3 to the cylindrical heat shield body 11 of the heat shield 1, and therefore the cylindrical heat shield body 11 does not scald the user's hand. Further, the cylindrical heat shield body 11 of the heat shield 1 protects the nursing bottle body 3 against breaking. Even if the nursing bottle body 3 is broken, the broken chips can be kept inside the cylindrical heat shield body 11 of the heat shield 1, prohibiting the baby from touching or eating the broken chips.

In conclusion, the invention provides a heat-insulation safety nursing bottle, which does not scald the user's hand and effectively protects the nursing bottle body against breaking.

Even if the nursing bottle body is broken, the broken chips can be kept inside the heat shield, prohibiting the baby from touching or eating the broken chips.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A heat-insulation safety nursing bottle, comprising:
a nursing bottle body comprising a bottleneck and an outer thread extending around the periphery of said bottleneck;
a nipple mounted on said bottleneck of said nursing bottle body;
a heat shield cap fastened to said bottleneck of said nursing bottle body to hold down said nipple, said heat shield cap comprising a first inner thread disposed near a bottom side thereof, a center mounting through hole for the passing of said nipple, and a second inner thread spaced above said first inner thread and threaded onto the outer thread of said nursing bottle body; and
a cylindrical heat shield body fastened to said heat shield cap and surrounding said nursing bottle body at a predetermined distance, said cylindrical heat shield body comprising an outer thread extending around the periphery thereof and threaded into said first inner thread of said heat shield cap.

2. The heat-insulation safety nursing bottle as claimed in claim 1, wherein said center mounting through hole of said heat shield cap is configured to fit said nipple that is configured subject to International Standards Organization (ISO) standards.

3. The heat-insulation safety nursing bottle as claimed in claim 1, wherein said second inner thread of said heat shield cap is configured to fit said nipple that is configured subject to International Standards Organization (ISO) standards.

4. A heat-insulation safety nursing bottle, comprising:
a nursing bottle body comprising a bottleneck, an outer thread extending around the periphery of said bottleneck, and a bottom opening in a bottom side thereof;
a breathing bottom cover fastened to said bottom opening of said nursing bottle body;
a nipple mounted on said bottleneck of said nursing bottle body;
a heat shield cap fastened to said bottleneck of said nursing bottle body to hold down said nipple, said heat shield cap comprising a first inner thread disposed near a bottom side thereof, a center mounting through hole for the passing of said nipple, and a second inner thread spaced above said first inner thread and threaded onto the outer thread of said nursing bottle body; and
a cylindrical heat shield body fastened to said heat shield cap and surrounding said nursing bottle body at a predetermined distance, said cylindrical heat shield body comprising an outer thread extending around the periphery thereof and threaded into said first inner thread of said heat shield cap.

5. The heat-insulation safety nursing bottle as claimed in claim 4, wherein said breathing bottom cover is press-fitted into said bottom opening of said nursing bottle body, comprising a rim extending around of the periphery thereof stopped outside said nursing bottle body, a center rounded cone disposed at the center thereof, and a crevice formed in said center rounded cone.

6. The heat-insulation safety nursing bottle as claimed in claim 4, wherein said cylindrical heat shield body comprises an air vent located on a bottom side thereof.
